(19) United States
(12) Patent Application Publication
(10) Pub. No.: US 2008/0030320 A1
(43) Pub. Date: Feb. 7, 2008

(54) Agricultural lift with data gathering capability

(75) Inventors: Timothy Amos Wilcox, Loraine, IL (US); Douglas Jeffrey Dickman, Normal, IL (US); Noel Wayne Anderson, Fargo, ND (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/498,454

(22) Filed: Aug. 3, 2006

(51) Int. Cl. G08B 19/00; G08B 13/14; G06F 17/00; G06F 7/00

(52) U.S. Cl. 340/521; 340/572.8; 235/375; 700/225

(57) ABSTRACT

An agricultural data system including a vehicle, a lift mechanism associated with the vehicle, an RFID reader and a weight sensor system. The RFID reader is associated with the vehicle and/or the lift mechanism and provides for the reading of an RFID tag on an agricultural produce container. The weight sensor system is associated with the vehicle and/or the lift mechanism and it determines a weight of the container.

### FIELD OF THE INVENTION

The present invention relates to an agricultural lift, and, more particularly to an agricultural lift system having data gathering capability.

### BACKGROUND OF THE INVENTION

Fruit and vegetable harvesting often involves the loading of bins and/or pallets of produce that has just been harvested. The bins or pallets are then transported to a storage or processing facility. The bins and pallets, henceforth referred to herein as containers, are frequently reused and may be full, partially full or empty at any particular time. The containers are moved within a field or orchard environment and then indoors for storage and/or processing. Tractors with forks attached to a three-point hitch are often used in the field or orchard to move the containers.

Forklifts are often used inside storage facilities and are sometimes outfitted with radio frequency identification (RFID) readers to track material movement within the facility. Loads moved by the forklifts in warehouses almost always have weights or quantities that are predetermined, for example, a pallet of X or a barrel of Y, etc. So variations of weight of the loads are not an issue. The problem often encountered with produce is that it does not have uniform weights or volumes, because the weather and ground conditions that lead to the harvesting time result in varying water content of the produce for a given volume. Additionally the amount of produce within a container can vary significantly from container to container.

What is needed in the art is a timely and efficient process for gathering data on containers in the field or orchard environment.

### SUMMARY OF THE INVENTION

The present invention, in one form thereof, comprises an agricultural data system including a vehicle, a lift mechanism associated with the vehicle, a Radio Frequency Identification (RFID) reader and a weight sensor system. The RFID reader is associated with either the vehicle or the lift mechanism for the reading of an RFID tag on an agricultural produce container. The weight sensor system is associated with either the vehicle or the lift mechanism. The weight sensor system determines a weight of the container.

### BRIEF DESCRIPTION OF THE DRAWINGS

FIG. 1 is a perspective view of a tractor using an embodiment of a data gathering device of the present invention;

FIG. 2 is a view of the data gathering device attached to the tractor of FIG. 1;

FIG. 3 is a side view of the data gathering device of FIGS. 1 and 2 being utilized by a tractor loading containers upon a transport vehicle; and

FIG. 4 is a schematical representation of the elements of the data gathering device of FIGS. 1-3.

### DETAILED DESCRIPTION OF THE INVENTION

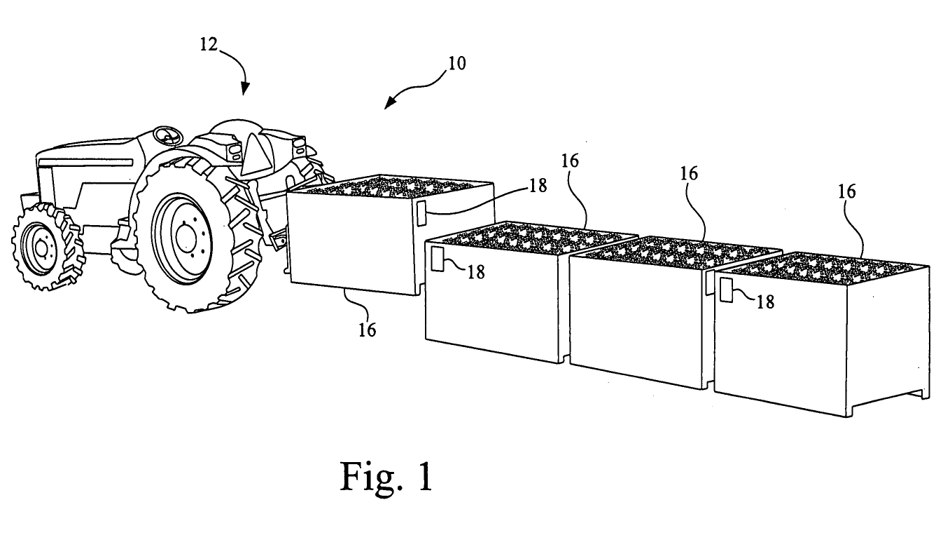

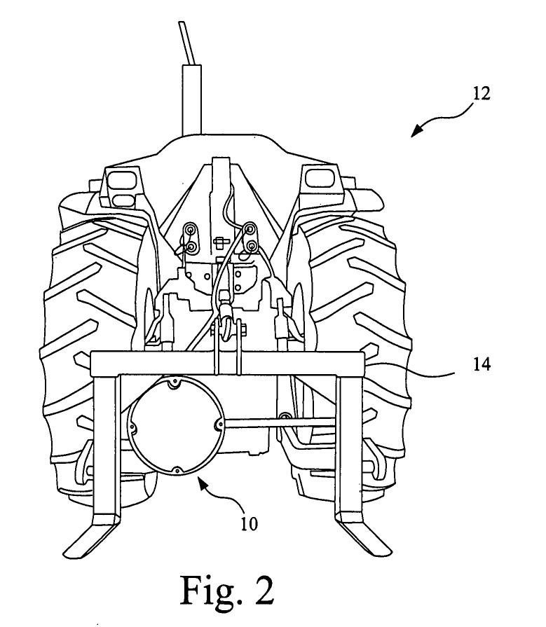

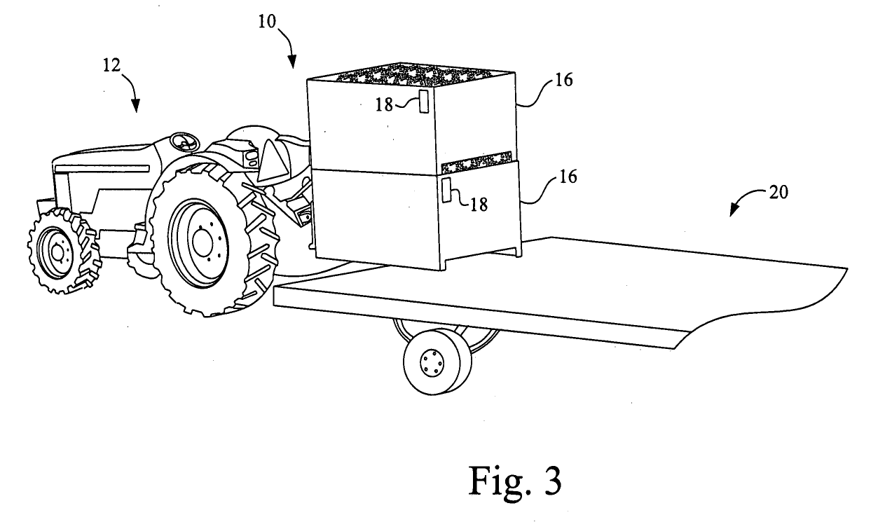

Referring now to the drawings, and more particularly to FIGS. 1-3, there is shown a data gathering system 10 associated with lift vehicle 12 having a fork system 14. Lift vehicle 12 moves containers 16 about a field, each of containers 16 includes an RFID tag 18 located on at least one surface of container 16. RFID tag 18 responds to a signal from data gathering system 10 and provides information thereto. Information may include identifying number, an empty weight of the container, and other information, such as temperature, relative to container 16. Lift vehicle 12 may be a tractor 12 having a forklift 14 associated with a three-point hitch on the rear of tractor 12. Tractor 12 can lift containers 16 and stack them vertically and then lift the vertical stack, as shown in FIG. 3, where tractor 12 is lifting two containers 16 upon a transport vehicle 20. Transport vehicle 20 may be a truck 20, which will transport containers 16 from the field.

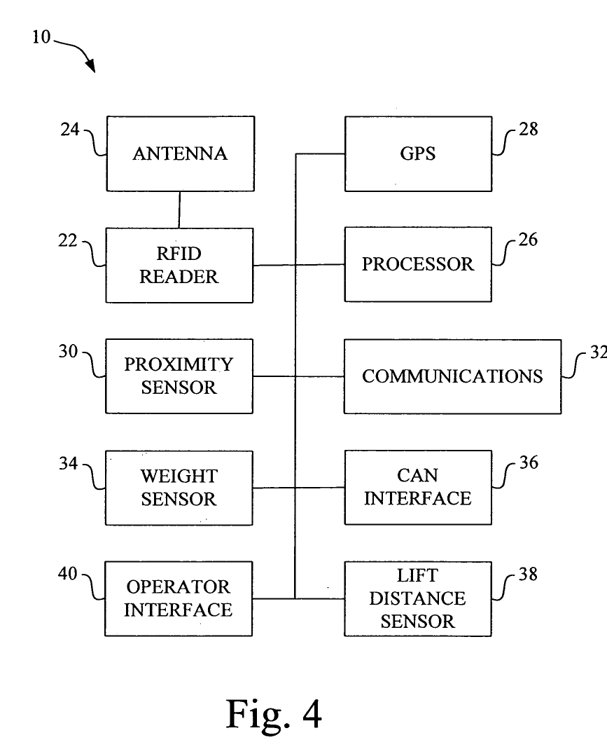

Now, additionally referring to FIG. 4 there is schematically shown data gathering system 10, which includes RFID reader 22, an antenna 24, a processor 26, a global positioning system (GPS) 28, a proximity sensor 30, a communications module 32, a weight sensor 34, a Controller Area Network (CAN) bus interface 36, a lift distance sensor 38 and an operator interface 40. RFID reader 22 is directly connected to antenna 24, which may be a directional antenna 24 to localize the area which signals are directed from RFID reader 22 and from which information is received from RFID tag 18.

Processor 26 interfaces with each of the elements of data gathering system 10 and provides data storage for information gathered in the operation of system 10. GPS 28 provides localization information for information relative to the positioning of containers 16 by tractor 12. Proximity sensor 30 provides a signal when a container 16 is proximate to fork system 14, which can then be utilized by a processor 26 to activate RFID reader 22. Communications module 32 may be a disk storage device 32 or a radio frequency or other wireless communication device 32. Communications from system 10 may be done in a delayed manner, upon being queried, or continuously on a real-time basis.

Weight sensor 34 may be associated with the forks of fork system 14 or the lift interface between lift vehicle 12 and fork system 14. Weight sensor 34 provides weight information on container 16, when a container 16 is lifted, thereby providing weight information that can be associated with the identification information received by way of RFID reader 22 in its query of RFID tag 18. Weight sensor 34 may be associated with lift distance sensor 38, which provides a calculation on the energy expended in lifting containers 16, to thereby estimate the weight of containers 16. Information from lift distance sensor 38 is acquired by way of CAN bus interface 36 associated with tractor 12.

Operator interface 40 provides for the operator to visually or audibly receive feedback upon the operation of system 10. For example, if RFID reader 22 reads an RFID tag 18 it may produce an audible beep signal or by way of a visual indication, thereby indicating a completed read operation. Further, operator interface 40 may include a re-settable counter allowing the operator to have a count of the number of lift operations performed since the last reset of the counter.

In managing the produce chain from the field to the processing plant, it is very useful to know weights and locations of containers 16. This enables timely and efficient processing of the contents of containers 16. Timely in that the produce, which is most perishable can be given a priority and moved from the field to processing without getting delayed or lost. Efficient in that like grades of produce can be routed and processed in full batches, minimizing any equipment or process changes that may be needed at the processing plant to process the particular grade of produce.

Data obtained by RFID reader 22 is communicated to processor 26. RFID reader 22 may be activated in a number of ways including, but not limited to, periodic activation, an activation in response to a signal from proximity sensor 30, a prompting by the user by way of operator interface 40 or in response to a lift command detected by way of CAN interface 36. Three-point hitches are often controlled by electronic control units and a command to perform a hitch-lift operation would be present in the electronic control unit and it is passed by way of a CAN bus linking the operator hitch control to the electronic control unit, which can be interpreted by CAN bus interface 36.

As many containers are proximate to data gathering system 10, such as shown in FIGS. 1 and 3, several ways can be utilized to resolve the particular identification tag 18 that is being read. A directional antenna 24 may be utilized to limit the number of extraneous tags being read. Further, the measure of the signal strength received by RFID reader 22 is passed on to processor 26 for evaluation to determine which tag is on the container being lifted versus one that is adjacent thereto. Another way of determining the particular RFID tag 18 that has been read, is to compare the tag information read at the time of the initial lift to that obtained after tractor 12 has moved a distance away from the first reading of RFID tag 18. Reads that are duplicate and have similar signal strength after a movement of tractor 12 then likely represents the RFID tags 18 being carried by fork system 14.

Information from RFID tags 18 that are read but are not being currently transported is of value as well. For example, the RFID tag numbers can then be localized to a particular area associated with a position available from GPS 28. This information then localizes the position of other containers 16 for later processing and movement.

Since container 16 may be stacked, as shown in FIG. 3, while being transported, data gathering system 10 may include multiple RFID readers on fork system 14 spaced vertically or directed to positions where RFID tags 18 are expected to be positioned on containers 16. Again the use of directional antennas 24 and/or the use of received signal strength can distinguish containers on the top, middle and bottom positions if the containers are stacked three high. The positional information can be logged for later processing, for example when truck 20 is being loaded by tractor 12. Further, RFID reader 22 and/or antenna 24 may be movable and/or rotatable to direct the reading capabilities of RFID reader 22 in order to resolve the positioning of container 16.

The weight of container 16 can be measured in a number of ways, including but not limited to the use of load cells placed on surfaces of fork system 14 that are used in transferring the lift force to the container. Another method is to measure the energy being utilized to lift container 16. The energy method recognizes that the energy needed to lift container 16 a distance H is equal to MGH, where M is the mass of container 16 and G is the gravitational constant. Tractor 12 supplies this energy through hydraulic, electrical or mechanical mechanisms. Sensors are utilized to measure the parameters necessary to calculate the tractor energy transfer such as the time integral of V×I (V=voltage, I=current) during lifting for an electrical actuator. These implementation specific adjustments may be needed to make up for system inefficiencies and energy transfer.

Depending on the three-point hitch system design and the parameters being measured, a lift distance sensor 38 may be utilized. One such sensor senses the angles of the linkages in the three-point hitch that are read at the starting and ending points of the movement of container 16. Trigonometric identities and calculations are utilized by processor 26 to calculate the distance the forks are raised or lowered and to arrive at a system calculation of the energy transferred by tractor 12.

When loads are lifted, there are at least four loads of interest, the first indicating that there is no load on fork system 14, the second that indicates that a container 16 is present but empty on fork system 14, the third being a container 16 that is full, and fourthly a container 16 that is partially full. Processor 26 can utilize a table that provides the tare weight of container 16 based on a fixed value for all containers or tare weights that are associated with each container 16. Alternatively, the tare weight can be part of the information read from RFID tag 18. The tare weight then is subtracted from the total weight, sensed by weight sensor 34, to provide a net weight that is then associated with the lift operation and identified with the particular containers 16 weights and identification.

A positional sensor, such as GPS 28 provides localization information relative to the pickup and drop-off points of the containers 16 as well as routing information in the tracking of loads carried by tractor 12. In orchard operations, GPS 28 may be augmented by a tree row map for further localization information.

The data collected by processor 26 is stored in memory associated therewith and is eventually transferred to a back office supply chain and/or logistic computer system by way of a data transfer of communications module 32. This transfer can be accomplished in near real-time using long range wireless, such as a cellular telephone connection by way of communications module 32. Alternatively, other wireless methods such as proprietary radio systems such as Safari Radio, or Wi-Max (IEEE802.16). Since real-time data transfer comes at a cost, lower cost methods that delay the transmittal of data may be employed; such a transmission may employ the transmission of the data in packets. Other methods utilizing technologies such as Bluetooth with a data transfer occurring when tractor 12 is proximate to a Bluetooth access point. Alternative physical media such as compact flash cards can be loaded and removed from system 10 having data stored thereon by way of processor 26.

A visual output such as a LCD display may be a part of operator interface 40 having a map and other directional information located thereon.

An example of data obtained by the operating of data gathering system 10 may include a sequence of records for a container in an orchard as follows:
Date: Nov. 3, 2005
Time: 13:22
Action: Pick up
Container: 3705
Location: <lat 1 and Ion 1>
Date: Nov. 3, 2005
Time: 13:23
Action: Drop
Container: 3705
Location: <lat 2 and Ion 2>
Date: Nov. 3, 2005
Time: 15:03
Action: Pick up
Container: 3705
Weight: 743 lbs
Location: <lat 3 and Ion 3>
Date: Nov. 3, 2005
Time: 15:08
Action: Drop
Container: 3705
Location: <lat 4 and Ion 4>
<more produce is added to the container at a second location>
Date: Nov. 3, 2005
Time: 16:23
Action: Pick up
Container: 3705
Weight: 937 lbs
Location: <lat 5 and Ion 5>
Date: Nov. 3, 2005
Time: 16:35
Action: Drop
Container: 3705
Location: <lat 6 and Ion 6>

In the foregoing illustration, date and time information as to particular actions relative to a container 16 are illustrated, each of which are connected with the same container number 3705. The first action is a pickup and it is noticed that the weight is empty at a particular location shown as latitude 1 and longitude 1. One minute later it is seen that container 3705 is dropped at latitude 2 and longitude 2. The next entry shows that container 3705 is picked up and has a net weight of 743 lbs. The next entry shows that container 3705 has been delivered to latitude 4 and longitude 4. Sometime later container 3705 is picked up having a net weight of 937 lbs so it can be inferred that more produce has been added to container 3705 and that it has been picked up at a new location indicating that it had been moved by some other vehicle subsequent to the prior operation. The last entry indicates that the container is then positioned at latitude 6 and longitude 6. It is to be understood that this information is merely one example of the type of data that can be obtained utilizing data gathering system 10.

Having described the preferred embodiment, it will become apparent that various modifications can be made without departing from the scope of the invention as defined in the accompanying claims.

1. An agricultural data system, comprising:
a vehicle;
a lift mechanism associated with said vehicle;
a Radio Frequency Identification (RFID) reader associated with one of said vehicle and said lift mechanism for the reading of an RFID tag on an agricultural produce container; and
a weight sensor system associated with at least one of said vehicle and said lift mechanism, said weight sensor system determining a weight of the container.

2. The agricultural data system of claim 1, wherein said weight sensor system is associated with the lift mechanism.

3. The agricultural data system of claim 2, wherein said weight sensor system includes load cells.

4. The agricultural data system of claim 1, further comprising a processor that obtains and stores identification data from the RFID tag and associates said weight with said identification data.

5. The agricultural data system of claim 4, further comprising a global positioning system communicatively coupled with said processor, said processor obtaining positional information from said global positioning system and associating said positional information with said identification data.

6. The agricultural data system of claim 1, further comprising a directional antenna associated with said RFID reader.

7. The agricultural data system of claim 1, further comprising a communications device that communicates information from the reading of the RFID tag and said weight information.

8. The agricultural data system of claim 1, further comprising an operator interface that indicates that said RFID reader has read information from the RFID tag.

9. The agricultural data system of claim 1, further comprising a proximity sensor that triggers said RFID reader to read the RFID tag.

10. The agricultural data system of claim 1, further comprising a processor that accesses information relative to an empty weight of said container and provides a net weight of produce in the container.

11. A data gathering system associated with an agricultural vehicle having a lift mechanism, said data gathering system comprising:
a Radio Frequency Identification (RFID) reader associated with one of the vehicle and the lift mechanism for the reading of an RFID tag on an agricultural produce container; and
a weight sensor system associated with at least one of the vehicle and the lift mechanism, said weight sensor system determining a weight of the container.

12. The data gathering system of claim 11, wherein said weight sensor system is associated with the lift mechanism.

13. The data gathering system of claim 12, wherein said weight sensor system includes load cells.

14. The data gathering system of claim 11, further comprising a processor that obtains and stores identification data from the RFID tag and associates said weight with said identification data.

15. The data gathering system of claim 14, further comprising a global positioning system communicatively coupled with said processor, said processor obtaining positional information from said global positioning system and associating said positional information with said identification data.

16. The data gathering system of claim 11, further comprising a directional antenna associated with said RFID reader.

17. The data gathering system of claim 11, further comprising a communications device that communicates information from the reading of the RFID tag and said weight information.

18. The data gathering system of claim 11, further comprising an operator interface that indicates that said RFID reader has read information from the RFID tag.

19. The data gathering system of claim 11, further comprising a proximity sensor that triggers said RFID reader to read the RFID tag.

20. The data gathering system of claim 11, further comprising a processor that accesses information relative to an empty weight of said container and provides a net weight of produce in the container.

21. A method of gathering data about agricultural produce, comprising the steps of:
lifting an agricultural container in a field environment;
weighing said agricultural container to obtain a weight thereof during said lifting step;
reading an RFID tag on said container to obtain an identifier for said agricultural container; and
associating said identifier with said weight.

22. The method of claim 21, further comprising the step of obtaining a position of said agricultural container from a global positioning system.

23. The method of claim 22, further comprising the step of combining said identifier, said weight and said position in a data record.

24. The method of claim 23, further comprising the step of communicating said data record to a computer.
